(19) United States
(12) Patent Application Publication
(10) Pub. No.: US 2021/0004865 A1
(43) Pub. Date: Jan. 7, 2021

(54) Business Capacity Utilization System and Method

(71) Applicant: Josephine Marchese, Toronto (CA)

(72) Inventor: Josephine Marchese, Toronto (CA)

(21) Appl. No.: 16/458,314

(22) Filed: Jul. 1, 2019

(51) Int. Cl. G06Q 30/02; H04L 29/08; G06Q 30/00

(52) U.S. Cl. CPC G06Q 30/0254; G06Q 30/018; H04L 67/34

(57) ABSTRACT

A software application that is configured to broker interactions intermediate a plurality of businesses and clients wherein the software application will attempt to facilitate the consumption of excess capacity of the businesses. The present invention is executed via a software platform controlled by an operator wherein the operator enrolls a plurality of businesses and clients. The businesses establish and publish a capacity calendar wherein the capacity calendar provides information as to the availability of the product or service of the business. The clients establish a preferred business list either by identification of a particular business or category. The software application provides cross-referencing of the product or service availability and notifies clients upon availability of a service or product. The operator of the present invention further provides reporting and advertising for businesses enrolled with the present invention. A reward system is associated with purchases made through the present invention.

### FIELD OF THE INVENTION

The present invention relates generally to business development systems and methods, more specifically but not by way of limitation, a business method and system that is configured to operably couple business and consumers wherein the businesses are to fill excess capacity within a shortened time period and wherein the present invention facilitates the transaction to meet the customer and business need.

### BACKGROUND

Millions of businesses engage in a business to consumer model as opposed to a business to business model. As is known in the art there are many challenges when managing a business to consumer model business. Numerous challenges such as forecasting supply chain needs and managing the expected capacity on a day to day business face these business owners. These types of businesses often deal with cyclicality in both consumer demand and the ability to fulfill that demand. By way of example but not limitation, businesses such as restaurants will often operate on a reservation system wherein their seating capacity for the evening is reserved in advance. Other businesses such as but not limited day care facilities and other service providers offer a longer term service to their customers with typically a limited availability. The aforementioned businesses always focus on optimizing their utilization of capacity. In order to achieve desired operating margins the utilization rate of the business capacity must typically be maintained above a certain threshold.

One issue with the aforementioned type of business is the ability to backfill sudden available capacity. By way of example but not limitation, if a restaurant receives a cancellation with only a few hours notice or experiences a no-show towards the beginning of a meal shift, this can result in a less than desired utilization rate and as such a reduced operating objective. Additionally, there may be consumers that had desired to patronize the business but were unable to do so based on the capacity of the business being initially reserved for that time period.

Accordingly, there is a need for a business capacity system and method that is operable to facilitate a communication between businesses and consumers to provide notification of available capacity within a short period of time.

### SUMMARY OF THE INVENTION

It is the object of the present invention to provide a business capacity utilization system and method that improves the ability to utilize short term available capacity wherein the system of the present invention is software based.

Another object of the present invention is to provide a software application that facilitates the connection between a business and its potential clients so as to improve capacity utilization of the business wherein the present invention provides registration of a multitude of businesses and clients.

A further object of the present invention is to provide a business capacity utilization system and method that improves the ability to utilize short term available capacity wherein the registered clients are able to access and view various business and select to receive notifications therefrom.

Still another object of the present invention is to provide a software application that facilitates the connection between a business and its potential clients so as to improve capacity utilization of the business wherein the present invention facilitates the ability for a client to establish a preferred business list to receive availability or promotional notifications therefrom.

An additional object of the present invention is to provide a business capacity utilization system and method that improves the ability to utilize short term available capacity wherein the operator of the present invention provides oversight reporting such as but not limited to bookings, cancellations, trade reports and regulatory reporting.

Yet a further object of the present invention is to provide a software application that facilitates the connection between a business and its potential clients so as to improve capacity utilization of the business wherein the present invention provides the ability for a client to specify dates and/or timelines for which they are seeking a service or product from a business registered with the present invention.

Another object of the present invention is to provide a business capacity utilization system and method that improves the ability to utilize short term available capacity wherein the present invention facilitates the ability for a registered client to edit their preferred business list.

Still an additional object of the present invention is to provide a software application that facilitates the connection between a business and its potential clients so as to improve capacity utilization of the business wherein the present invention wherein the registered clients collect rewards for purchases made through the present invention that can be subsequently redeemed.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an exemplary process flow of an operator and business registered with the present invention; and

FIG. 2 is an exemplary process flow of a client engaging with the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a business capacity utilization system and method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

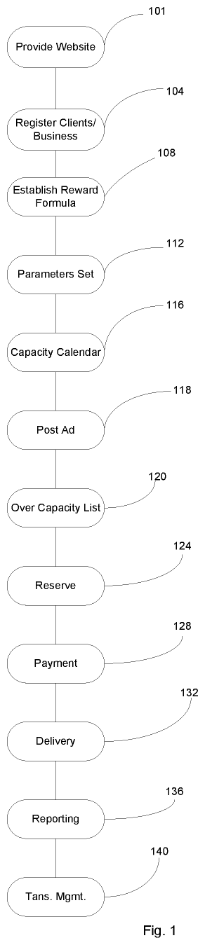

Referring in particular to FIG. 1 submitted herewith, a process flow of an operator of the business capacity utilization system and method 100 is diagrammed therein. In step 101, the operator of the business capacity utilization system and method 100 provides a website wherein the website provides the graphical interface to execute the tasks discussed further herein. It should be understood by those skilled in the art that execution of such tasks are implemented utilizing conventional computing equipment operably coupled to the Internet utilizing suitable communication protocols. The present invention leverages software platforms operably integrated with a website and a software application that is operably installed on portable computing devices such as but not limited to a smart phone. Step 104, the operator will provide promotion of the website of the business capacity utilization system and method 100 and both businesses and clients will initiate utilization thereof. It should be understood within the scope of the present invention that the businesses being solicited for registration with the present invention can be solicited by the operator of the business capacity utilization system and method 100 or by an already registered client of the present invention. During initial utilization of the website the businesses and clients will establish a registered account with the business capacity utilization system and method 100. It is contemplated within the scope of the present invention that the account registration would incorporate parameters such as but not limited to name, email address, physical address, telephone, website address of the business and social media accounts. Furthermore, for appropriate businesses the business can further provide certifications and/or awards such as but not limited to food safety certifications and Better Business Bureau rankings.

Step 108, provides the ability for businesses to establish a rewards system and/or participate in a rewards system that could be established by the operator of the business capacity utilization system and method 100. It is contemplated within the scope of the present invention that the registered businesses and/or operator could provide a rewards system for clients cumulative purchases. By way of example but not limitation, this could be done utilizing a points system wherein registered users account is credited points for each purchase that can be subsequently redeemed with either the business from which they were earned or with other businesses participating in the business capacity utilization system and method 100. In step 112, the software of the present invention will facilitate the setting of various term and conditions parameters for the businesses being registered with the business capacity utilization system and method 100. Terms such as payment terms, timelines, dates, pricing, quantity/capacity and other restrictions are established in order to provide guidance for participation in the business capacity utilization system and method 100. The aforementioned parameters are reviewed, validated and agreed to by the operator of the business capacity utilization system and method 100 and businesses registering therewith.

In step 116, ensuing registration with the business capacity utilization system and method 100 the operator thereof collaborates with the registered business to establish a capacity calendar. This capacity calendar can be revised at various alternate intervals once established such as but not limited to daily or weekly. The capacity calendar provides either wait list information or available capacity at particular times and dates. While a service oriented business is being utilized herein as an example, it should be understood that the business capacity utilization system and method 100 can additionally be utilized for product based businesses wherein product based businesses provide information on particular products and remaining inventory thereof. Once a capacity calendar has been established for a registered business, the operator of the business capacity utilization system and method 100 will make available to registered clients for viewing thereof. Registered clients can either reserve available capacity or place themselves on a wait list for that particular business. In step 118, a business will be provided the ability to post an advertisement relating to any available capacity. The advertisement will be sent to clients that have the businesses listed on their preferred business list or to other register clients as well. This advertisement posting term can be adjusted for duration and other parameters. Approval of the advertisement is required prior to posting. It is further contemplated within the scope of the present invention that the posting could be correlated to a region such as but not limited to a zip code.

Step 120, if a registered business has no availability during the term period of the capacity calendar, a client that desires to engage the business can be placed on an over capacity list. In the event that a revision of the capacity calendar yields available capacity that was previously unavailable, a notification will be sent to client(s) that are listed in the over capacity list. Once a business is registered and a capacity calendar is available to clients, the clients will reserve availability with the business in step 124. Step 128, if applicable a payment is made to the operator of the business capacity utilization system and method 100 for either the reservation with the registered business or the service/product to be delivered. It is contemplated within the scope of the present invention that the payment could be facilitated in various manners and at different times during the business/client interaction. By way of example but not limitation, the client could pay the operator of the business capacity utilization system and method 100 or could submit payment to the business directly.

In step 132, the product or service reserved by the client is delivered.

Step 136, the operator of the business capacity utilization system and method 100 will provide continuous reporting as part of operation of the business capacity utilization system and method 100. This reporting is operable to provide both clients and the businesses registered with the business capacity utilization system and method 100 various reports to understand activity and other parameters. By way of example but not limitation, reporting covering such parameters as bookings, cancellations, reward accumulation, client demographics, and trading are provided to businesses by the operator of the present invention. Step 140, the operator further provides any required transactional management and reporting. This can include but is not limited to cashing out an account or a transaction as well as collecting feedback about the businesses from the clients that have engaged therewith. Furthermore, integration of social media accounts and providing updates to the accounts of the present invention are further provided by the operator of the present invention. It is further contemplated within the scope of the present invention that the operator of the business capacity utilization system and method 100 will provide reporting to applicable regulatory authorities. By way of example but not limitation, the operator of the present invention will report to financial institutions and commerce agencies in the event of identifying suspected fraud on the part of one of the registered businesses of the business capacity utilization system and method 100. Identification of suspected fraud or other matter can be generated by the client of the business capacity utilization system and method 100 utilizing features of the software or through other means and by alternate entities.

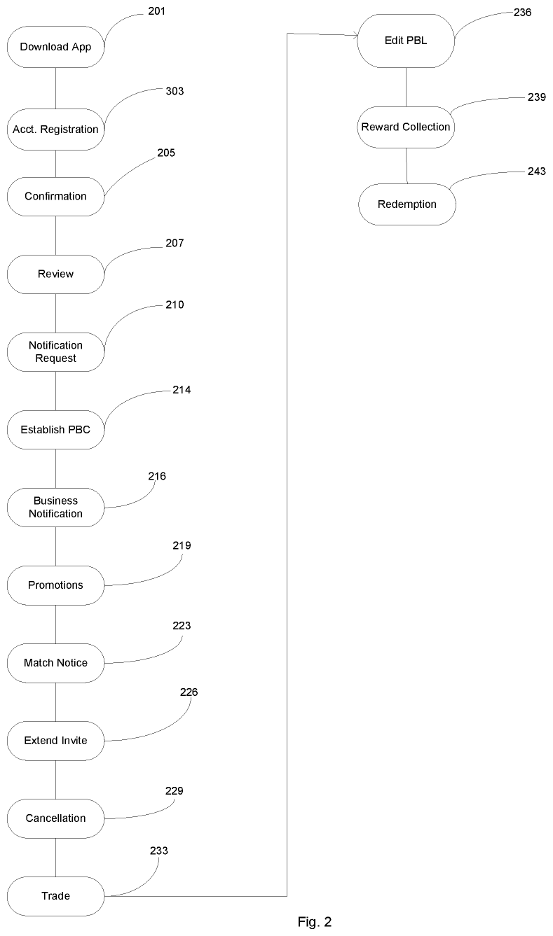

Referring now to FIG. 2 submitted herewith, an exemplary process flow of a client engaging with the business capacity utilization system and method 100 is diagrammed therein. In step 201, the client will download the remote software application from the website for installation and use on a computing device such as but not limited to a smart phone. Step 203, a client will initiate the registration process with the business capacity utilization system and method 100 wherein the software application of the present invention provides the necessary graphical interfaces to facilitate the process thereof. It is contemplated within the scope of the present invention that the registration process of the client will include but is not limited to name, contact information, demographic information and social media information. In step 205, the business capacity utilization system and method 100 will generate an introductory email that is delivered to the client wherein the introductory email provides confirmation of the account data entered and a welcome/instructions for use of the business capacity utilization system and method 100. In step 207, the client will browse the businesses available within the business capacity utilization system and method 100. The businesses are organized by category and can further be identified through either a keyword or name search. Furthermore, the businesses can be searched for utilizing geographic parameters such as but not limited to zip code. In the event that a desired business or category cannot be found, the software application of the present invention provides the client the ability to send a notification to the operator of the business capacity utilization system and method 100 in step 210. The notification can include but is not limited to a request for a particular business or category. Ensuing receipt of the notification the operator will either send a request to an identified business or to a list of businesses in an area or category specified by the client. In step 214, the client will begin to establish a preferred business list. The preferred business list establishes a register of businesses and/or types in which the client is interested in purchasing a product or service therefrom. The client can choose a business based on parameters such as but not limited to event type, timeline, available dates and quantity required. These parameters are entered into the preferred business list and associated with the selected business or business types. By way of example but not limitation, if a client desires to host a dinner party for ten people at an Italian restaurant within a particular time window, the aforementioned is entered into the software of the business capacity utilization system and method 100. Upon receipt of the information, the software of the present invention cross references with the capacity calendar of either the selected business or category. In the event a match is not able to be facilitated, the present invention will maintain record of the request and continuously cross reference all applicable capacity calendars until availability is identified or cancellation of the request has been executed by the client.

In step 216, a notification is transmitted to a business ensuing identification thereof from a client wherein the client desires the business to be a registered business with the business capacity utilization system and method 100. The business if desired will initiate registration with the present invention as described herein. Step 219, the business will plan, develop and implement various promotional activities. These promotional activities can be structured in numerous alternate manners. By way of example but not limitation, the promotions can be directed towards clients that have that business and/or category as part of the preferred business list. Alternatively, promotional activities can be directed towards a particular timeline or offering. It should be understood within the scope of the present invention that numerous types of promotions and incentives could be included in any promotional campaign. In step 223, a match notification will be sent to both a business and the client in which the desired services/products and capacity calendar availability parameters are in alignment. By way of example but not limitation, if a client has entered a dinner for ten on a certain date at a restaurant that was either selected by category or by name and availability is either initially or subsequently existing, a notification will be sent to the client. The client will either accept or reject the notification and the business will be notified of the acceptance or rejection. If accepted, in step 226 the client can utilize the software of the present invention to extend the invitation for the selected event to other entities known by the client such as but not limited to friends that either are or are not enrolled with the business capacity utilization system and method 100.

In step 229, a client can cancel the accepted service or product at anytime prior to the purchase thereof. In the event of a cancellation, the business is notified and the capacity calendar is updated. Step 233, as an alternative to a cancellation, the client is provided a trade option by the software of the present invention. A trade option will allow a client to trade the service or product to which they have committed for either another service or product or with another client that has a service or product that they would like to exchange for the service or product to which they have committed. It should be understood within the scope of the present invention that the software application facilitates the identification and ability to execute the aforementioned trades. In step 236, a client can continuously edit their preferred business list as part of their engagement with the business capacity utilization system and method 100. A preferred business list is considered dynamic and can be based on short term needs and/or preferences of the client. Step 239, the business capacity utilization system and method 100 includes a reward incentive program for clients use thereof. It should be understood within the scope of the present invention that the rewards are accumulated during utilization of the business capacity utilization system and method 100 and not at a particular time or interval of the process diagrammed and described herein. As previously discussed herein the rewards program of the business capacity utilization system and method 100 could include but is not limited to points wherein points are redeemable. Step 243, ensuing accumulation of a sufficient amount of reward units, a client can redeem the rewards for purchase of a good or service offered by a registered business of the business capacity utilization system and method 100.

It should be understood that the process flows submitted herewith are exemplary and do not function to provide limitation as to the order or quantity of certain actions of engagement with the business capacity utilization system and method 100 by either the client or a business registered therewith. Following are additional functional features that contemplated within the scope of the business capacity utilization system and method 100 and executed utilizing the software thereof. An auto-reservation service wherein if a client request and capacity calendar availability are correlated, the software of the present invention will automatically reserve for the client and send a notification to the business and client. Fee collection by the operator of the business capacity utilization system and method 100. More specifically but not by way of limitation, it is contemplated within the scope of the present invention that the monies required for the service or product could be collected by the operator of the present invention wherein a management fee could be deducted therefrom prior to transfer to the business fee. Additionally, business could pay a subscription fee to the operator of the business capacity utilization system and method 100 as part of the registration process.

Additionally, it is further contemplated that registered clients can utilize the software of the present invention to generate and distribute a gift card for a designee of the clients choice. Another feature contemplated within the scope of the present invention is to require a timeline to respond to and either accept or reject a notification of an available service or product. Furthermore, a product or service review can be collected by the operator of the present invention subsequent delivery thereof. Alternatively, businesses can submit payment to the operator of the business capacity utilization system and method 100 for a advertisement posting wherein at least one parameter of the posting is the term thereof. It should be understood within the scope of the present invention that the acceptance, rejection and cancellation of the service or product could further include rescheduling. Additionally, the present invention provides the ability to re-post and sell short term cancellations wherein a promotional offer may be extended therewith.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A business capacity utilization method that is operable to fill excess capacity upon availability thereof comprising the steps of:
providing a website, said website offering a graphical interface for utilization of the business capacity utilization method;
downloading a software application, wherein a business or a client will download the software application onto a computing device;
establishing an account, wherein a plurality of businesses and clients establish an account wherein the account contains information pertaining to each entity;
reviewing available products or services, wherein at least one client will review products or services provided by businesses having an account;
establishing a preferred business list, wherein at least one client will establish a preferred business list, wherein the preferred business list contains a list of businesses from which the at least one client desires to purchase a product or service;
providing a capacity calendar, wherein each business provides a capacity calendar that is visible to all clients having an account;
identifying an excess capacity for a business, wherein a business having an account will recognize excess capacity for a product or service;
posting availability of excess capacity for a business, wherein the business will provide notification of availability to clients;
accepting the excess capacity, wherein a client will receive the notification of availability and enter acceptance thereof; and
reconciling the capacity calendar, wherein the capacity calendar is reconciled to be updated with either excess capacity availability or quantity of a service or product available.

2. The business capacity utilization method as recited in claim 1, and further including the step of specifying a timeline for the excess capacity to be available, wherein the business will restrict the availability to respond to the notification of excess capacity availability.

3. The business capacity utilization method as recited in claim 2, and further including the step of providing a business a notification of a desired service or product, wherein a client will provide a business a notification of a need to purchase a product or service offered by the business.

4. The business capacity utilization method as recited in claim 3, and further including the step of providing a match notification, wherein the software application provides notice to both a client and a business that a match for a desired service or product is available.

5. The business capacity utilization method as recited in claim 4, and further including the step of extending an invitation to at least one other client for a service or product, wherein a client who has accepted a purchase of a service or product will extend an invitation to at least one other client to participate in consumption of the product of service.

6. The business capacity utilization method as recited in claim 5, and further including the step of trading two services or products, wherein two clients exchange a service or product for another.

7. The business capacity utilization method as recited in claim 6, and further including the step of providing regulatory reporting, wherein an operator provides reporting of non-compliance to both a client and a regulatory agency.

8-14. (canceled)

15. A business capacity utilization method that is operable to fill excess capacity during periods of availability thereof comprising the steps of:
providing a website, said website offering a graphical interface for utilization of the business capacity utilization method;
downloading a software application, wherein a business or a client will download the software application onto a computing device;
registering a plurality of businesses, wherein an operator of the method will register a plurality of businesses, and wherein during registration of the plurality of businesses the operator will collect information about the plurality of businesses;
enrolling a plurality of clients, wherein the operator will solicit and enroll a plurality of clients that are interested in purchasing products or services from the plurality of businesses;
providing a confirmation of enrollment, wherein the operator will provide an electronic notification to clients upon enrollment;
reviewing available products or services, wherein clients will review products or services provided by businesses having an account;
establishing a preferred business list, wherein clients will establish a preferred business list, wherein the preferred business list contains a list of businesses from which the clients desire to purchase a product or service;
providing a capacity calendar, wherein each business provides a capacity calendar that is visible to all clients having an account;
identifying an excess capacity for a business, wherein a business having an account will recognize excess capacity for a product or service;
posting availability of excess capacity for a business, wherein the business will provide notification of availability to clients;
receiving a match notification, wherein a client receives a notification that a business offering a product or service fulfilling the requirements of the client is available;
accepting the excess capacity, wherein a client will receive notification of availability and enter acceptance thereof; and
reconciling the capacity calendar, wherein the capacity calendar is reconciled to be updated with either excess capacity availability or quantity of a service or product available;
delivering the product or service, wherein the product or service purchased is delivered by the business; and
receiving feedback from the client, wherein the operator solicits and records feed back about the product or service purchased.

16. The business capacity utilization method that is operable to fill excess capacity as recited in 15, and further including the step of providing regulatory reporting, wherein an operator provides reporting of non-compliance to both a client and a regulatory agency.

17. The business capacity utilization method that is operable to fill excess capacity as recited in 16, and further including the step of trading two services, wherein one of said multitude of clients trades a purchased product or service for a product or service purchased from another of said multitude of clients.

18. The business capacity utilization method that is operable to fill excess capacity as recited in 17, and further including the step of monitoring the parameters of the capacity calendar and the preferred business list for a match, wherein if parameters of the capacity calendar for a business and parameters of the preferred business list match an alert is sent to the operator.

19. The business capacity utilization method that is operable to fill excess capacity as recited in 18, and further including the step of posting an advertisement, wherein the operator permits posting of an approved advertisement by a business for a specified time period.

20. The business capacity utilization method that is operable to fill excess capacity as recited in 19, and further including the step of collecting rewards, wherein the clients collect rewards for each service or product purchased through utilizing the method.
